(19) United States
(12) Patent Application Publication
(10) Pub. No.: US 2013/0191438 A1
(43) Pub. Date: Jul. 25, 2013

(54) CONTENTS DISTRIBUTION SYSTEM, DISTRIBUTION SERVER, AGENT SERVER, AND COMPUTER PROGRAM

(71) Applicant: Panasonic Corporation, Osaka (JP)

(72) Inventor: Kazuo FUJIMOTO, Osaka (JP)

(73) Assignee: PANASONIC CORPORATION, Osaka (JP)

(21) Appl. No.: 13/745,986

(22) Filed: Jan. 21, 2013

(30) Foreign Application Priority Data
Jan. 23, 2012 (JP) 2012-010655

(51) Int. Cl. H04L 29/06

(52) U.S. Cl. CPC H04L 67/42
USPC 709/202

(57) ABSTRACT

An exemplary contents distribution system includes a distribution server for distributing, to an information terminal, contents to which use right information for permitting playing the contents is set, and an agent server which distributes the contents to the information terminal in place of the distribution server when instructed from the distribution server. The distribution server includes a control unit for determining whether or not to execute surrogate distribution based on at least one of a load state of the distribution server and a load state of a network between the distribution server and the information terminal, and a distribution instructing unit for transmitting the use right information to the agent server and instructing the agent server to distribute the contents when it is determined that surrogate distribution is to be executed.

### BACKGROUND

1. Technical Field

The present disclosure relates to a contents distribution system that includes an agent server that distributes contents such as a recorded broadcast program in place of a video recorder or other types of distribution server.

2. Description of the Related Art

A known method of dubbing contents that are recorded by a conventional video recorder is to re-encode the contents in a manner suited to the playing environment (e.g., image resolution and audio encoding method) of a player to which the contents are dubbed, such as a tablet terminal or a DVD player. Japanese Patent Application Laid-open No. 2002-135717, for instance, discloses a signal processing method that uses the known method to convert encoding methods of visual data and audio data into optimum encoding methods.

One of mechanisms employed in digital television broadcasting in Japan to protect copyright is a method called “Dubbing 10”. The restrictions of Dubbing 10 allow the same set of digital broadcast contents recorded on a hard disk (hereinafter abbreviated as “HDD”) inside a video recorder to be dubbed to a recording medium (e.g., a DVD disc, a BD disc, or an SD card) that is loaded to the video recorder ten times or less, irrespective of whether or not the contents are re-encoded.

In addition, recent video recorders have a function of distributing recorded contents to a terminal connected via a network. Video recorders of this type execute distribution after re-encoding the contents in a manner suited to the playing environment (e.g., image resolution and audio encoding method) of the terminal.

When dubbing contents to a recording medium and simultaneously distributing the contents to a terminal via a network under the restrictions of Dubbing 10, the dubbing to a recording medium and the distribution to a terminal are allowed ten times or less, combined. This means that, in the case of the distribution to a terminal via a network without dubbing, contents can be distributed concurrently to ten terminals at maximum.

### SUMMARY

There has conventionally been a technical problem in that various factors including processing performance limitations of the video recorder impede re-encoding output that meets an increased number of distribution requests from terminals.

In the case of distributing the same set of contents concurrently to close to ten terminals following the operation rules of Dubbing 10, in particular, the number of terminals that can be used concurrently may be limited due to limitations in the processing performance of the video recorder and the like. This greatly inconveniences users who are denied the request for the distribution of the contents.

One non-limiting, and exemplary embodiment of the present disclosure provides a technique to accomplish stable distribution of contents while protecting copyright by newly providing an agent server and having the agent server perform the processing in place of the video recorder.

In one general aspect, a distribution server disclosed herein is connectable by wire or wirelessly to at least one information terminal and to an agent server, for distributing contents to which use right information for permitting playing the contents is set, the distribution server including: a control unit configured to determine whether to distribute the contents from the distribution server or to cause the agent server to distribute the contents based on at least one of a load state of the distribution server and a load state of a network between the distribution server and the at least one information terminal; and a distribution instructing unit configured to transmit the use right information to the agent server and instructing the agent server to distribute the contents when the control unit determines to cause the agent server to distribute the contents.

According to the above aspect, the agent server can perform a part of processing in place of the distribution server while protecting copyright. Contents are thus distributed stably to a plurality of information terminals different from one another in, for example, encoding method, resolution, and communication band.

These general and specific aspects may be implemented using a system, a method, and a computer program, and any combination of systems, methods, and computer programs.

Additional benefits and advantages of the disclosed embodiments will be apparent from the specification and Figures. The benefits and/or advantages may be individually provided by the various embodiments and features of the specification and drawings disclosure, and need not all be provided in order to obtain one or more of the same.

### BRIEF DESCRIPTION OF THE DRAWINGS

FIG. 1A is a conceptual diagram illustrating the basic configuration of each embodiment.

FIG. 1B is a configuration diagram of a program distribution system according to a first embodiment and a second embodiment, which includes a video recorder, a video recording center, and a plurality of receiving terminals.

FIG. 2 is a first processing procedure diagram of a program distribution system according to the first embodiment.

FIG. 3 is a second processing procedure diagram of the program distribution system according to the first embodiment.

FIG. 4 is a diagram illustrating an example of changes in the allotted use count of a program in surrogate distribution.

FIG. 5 is a diagram illustrating a configuration example of playing environment information of the receiving terminals.

FIG. 6 is a diagram illustrating a configuration example of recorded program information.

FIG. 7 is a processing procedure diagram for a case where streaming play is executed with the use of a program distribution system according to the second embodiment.

FIG. 8 is a configuration diagram of a program distribution system according to a third embodiment in which a service provider which has distributed a program to a video recorder handles distribution in place of the video recorder.

FIG. 9 is a processing procedure diagram of processing that is executed in the program distribution system via the distribution service provider according to the third embodiment.

### DETAILED DESCRIPTION

Before a description is given on concrete embodiments of the present disclosure, the basic concept of embodiments of the present disclosure is described first.

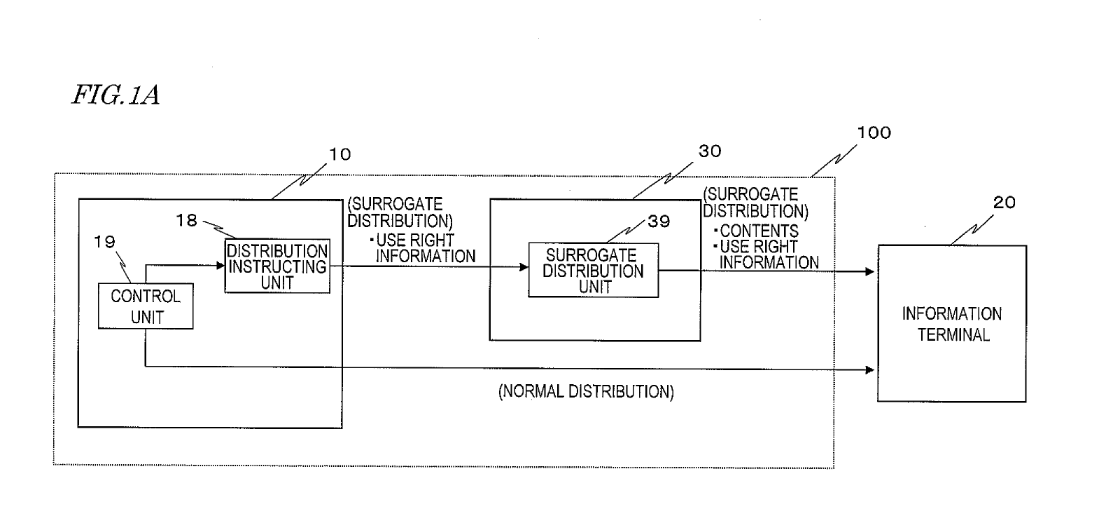

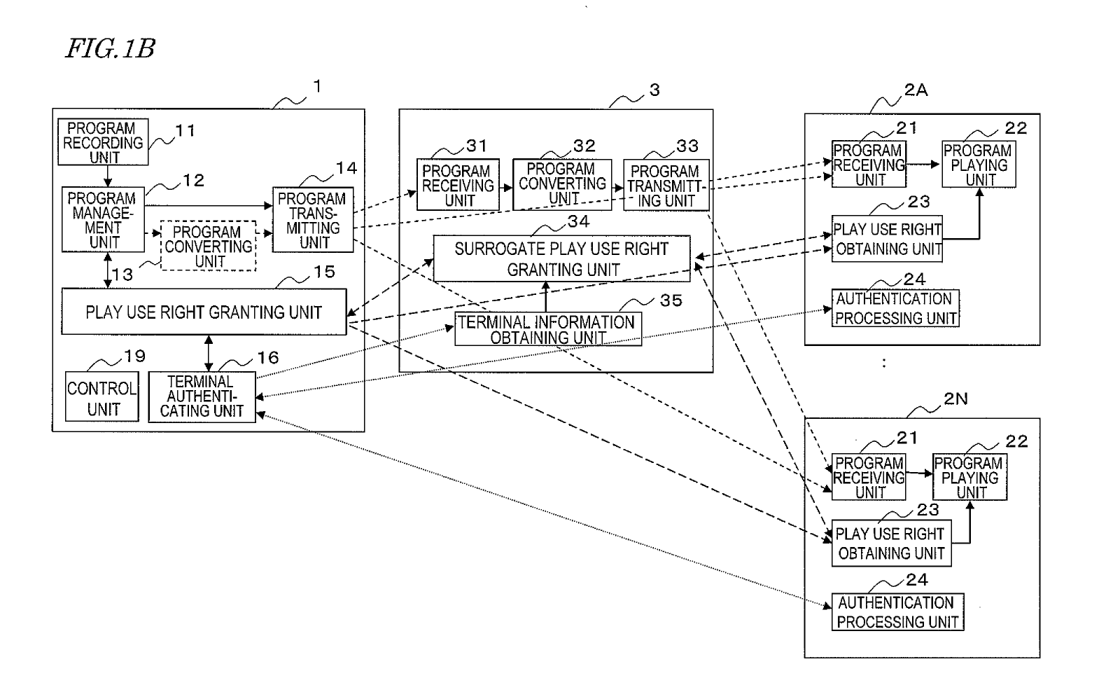

FIG. 1A is a block diagram illustrating the basic configuration of a contents distribution system 100 according to embodiments of the present disclosure. The distribution system 100 includes a distribution server 10, which is connected to at least one information terminal (computer) 20 in a manner that allows communication, and an agent server 30, which is connected to the distribution server 10 and to the information terminal 20 in a manner that allows communication. FIG. 1A shows one information terminal 20 for simplification, but a plurality of information terminals can be connected to the distribution server 10 and to the agent server 30 via a wired or wireless network. The information terminal 20, which is not a component of the contents distribution system 100 in the configuration of FIG. 1A, may be included among components of the system 100.

The information terminal 20 is a smart phone, a PC, a tablet terminal, or other computers. The information terminal 20 is capable of playing contents that are distributed from the distribution server 10 or the agent server 30.

The distribution server 10 and the agent server 30 are devices that have a function of providing contents to other computers connected thereto via a communication network. The distribution server 10 and the agent server 30 can be, for example, video recorders placed in homes, personal computers (PCs), or server computers of contents distributing providers.

The distribution server 10 keeps contents to be distributed typically in a built-in or external recording medium, and is capable of distributing the contents to the information terminal 20 in response to a request from the information terminal 20, or voluntarily without being dependent on the request. An example of the voluntary distribution is a configuration in which the distribution server 10 distributes the same video at once to a plurality of information terminals 20 set in advance. This configuration allows, for example, a chat among people who are watching the same video on separate terminals and the streaming distribution of a class or a lecture to a plurality of bases.

“Contents” in embodiments of the present disclosure are visual, audio, text, and other types of information from which a user can perceive visually or acoustically what is intended by the creator of the contents. Processing contents with a computer so that a user can perceive what is expressed in the contents is herein referred to as “playing contents”. Accordingly, “play” herein encompasses not only playing a video and audio but also displaying on a display device what is included in the contents, such as text or a still image. In the following description, playing contents may be referred to as “using” the contents.

Contents can be, for example, data of a recorded broadcast program or visual, audio, or other types of data obtained by downloading from a contents provider via a network. Alternatively, contents may be data that is dubbed from visual, audio, or other types of data recorded on a recording medium such as a DVD or a Blu-ray disc (BD).

Such contents are generally protected by copyright law, and there are accordingly mechanisms for restricting the excessive use of the contents. In the case of following the method of “Dubbing 10” in Japan, for example, the number of times contents are relocated or copied is restricted to ten times at maximum. A method called “copy once”, on the other hand, allows the relocation or copying of contents only once. In those methods, the remaining use count set to contents is subtracted by 1 each time the relocation or the copying is executed and, when the count reaches zero, the contents cannot be relocated or copied any more. Contents of which the remaining use count is zero therefore can no longer be distributed. There are also mechanisms that restrict the length of time in which contents can be used, instead of restricting the use by the number of times the contents have been used. An example of the mechanisms in video distribution is a method of restricting a period in which distributed contents can be played to a certain length of time since the downloading.

Playing contents that are restricted in those manners requires a “use right”. The use right is transmitted to the information terminal 20 as data having a given format along with the contents, and the information terminal 20 receiving the use right is permitted to play the contents. In the following description, information representing the use right may be referred to as “use right information”.

The distribution server 10 follows one of the copyright protection mechanisms described above and manages the use rights of respective contents so as to prevent unrestricted distribution of the contents. For instance, the distribution server 10 employs a mechanism which records, for each set of contents, information indicating the allotted use count of the set of contents in a recording medium of the distribution server 10 and subtracts 1 from the allotted use count of the set of contents each time the set of contents is distributed. The distribution server 10 in this case distributes contents to the information terminal 20 by transmitting use right information of the contents to the information terminal 20 in addition to data of the contents. The information terminal 20 cannot play the contents unless the use right information is obtained. After transmitting the contents along with the use right information to the information terminal 20, the distribution server 10 subtracts the allotted use count of the contents by 1.

The distribution server 10 sometimes distributes the same set of contents to a plurality of information terminals different from one another in performance and communication environment. The distribution server 10 in this case distributes the contents that are converted to suit the respective performance levels and communication environments of the plurality of information terminals 20. For instance, the visual/audio format that can be played, the pixel count of an image that can be displayed, the communication band of the connection environment, and the like may vary from one information terminal 20 to another. To distribute the same set of contents to such different information terminals 20, the distribution server 10 converts the contents to be distributed into data formats, compression ratios, and the like that are suited to the respective information terminals.

The distribution server 10 may find difficulties in distributing contents to the information terminal 20 for some reason. For instance, the distribution server 10 attempting to distribute contents to a large number of information terminals 20 concurrently may fail to distribute the contents to all of the information terminals due to limitations in the processing performance of the distribution server 10. In the mode where contents are converted into different formats to suit the respective information terminals 20 as described above, in particular, the heavy processing load on the distribution server 10 increases the possibility of failure to meet the requests of all of the terminals. Heavy traffic in communication lines between the distribution server 10 and the information terminals 20 and executing other types of processing such as video recording processing in the distribution server 10 also increase the risk to stable distribution.

As a solution, the distribution server 10 in the embodiments of the present disclosure instructs the agent server 30 to handle contents distribution in place of the distribution server 10. The agent server 30 which receives the instruction has the same distribution function as that of the distribution server 10 and, upon the reception of the instruction from the distribution server 10, distributes the contents to the information terminals 20 in place of the distribution server 10.

The distribution server 10 transmits use right information to the agent server 30 when instructing the agent server 30 on surrogate distribution. The agent server 30 adds the use right information to the contents and then distributes the contents to the information terminals 20. The information terminals 20 can thus play the contents.

In order to implement the function described above, the distribution server 10 includes, as illustrated in FIG. 1A, a control unit 19 for determining whether or not to execute surrogate distribution, and a distribution instructing unit 18 for instructing the agent server 30 on surrogate distribution when it is decided to execute surrogate distribution. The control unit 19 determines whether to distribute contents from the distribution server 10 or to distribute contents from the agent server 30 based on at least one of the load state of the distribution server 10 and the load state of the network between the distribution server 10 and the information terminals 20. When the control unit 19 determines that the contents are to be distributed by the agent server 30, the distribution instructing unit 18 transmits use right information that permits the use of the contents to the agent server 30 and instructs the agent server 30 to distribute the contents. When the control unit 19 determines that contents are to be distributed from the distribution server 10, the contents and use right information that permits the use of the contents are transmitted to the information terminals 20 via a distribution unit (not shown).

The agent server 30 includes a surrogate distribution unit 39 for distributing contents to the information terminals 20 upon reception of an instruction from the distribution instructing unit 18. The surrogate distribution unit 39 receives use right information from the distribution instructing unit 18, adds the use right information to the contents, and then transmits the contents to the information terminals 20. The information terminals 20 can thus play the contents.

In the case where the distribution server 10 and the agent server 30 hold the same set of contents, the distribution server 10 does not need to transmit contents data to the agent server 30. The agent server 30 in this case distributes the contents data held in itself to the information terminals 20. In the case where the agent server does not have contents data to be distributed, on the other hand, the contents data is transmitted from the distribution server 10 to the agent server 30 and then to the information terminals 20. The contents data transmitted from the agent server 30 to the information terminals 20 does not need to be completely identical with the contents data held in the distribution server 10. The two pieces of contents data are treated as the same set of contents even when, for example, the two have different compression ratios or formats or an insignificant scene is removed from one of the two because what is expressed by the two pieces of contents data is substantially the same.

With the configuration described above, use right information of contents is properly given to the agent server and the information terminals 20 when surrogate distribution is executed. This enables the distribution server 10 and the agent server 30 to manage the use count of the contents properly, and the load can thus be balanced in contents distribution while protecting copyright. As a result, smooth distribution is accomplished even when distribution by the distribution server 10 alone is difficult, as in the case where contents distribution is requested by a large number of information terminals 20 at once.

More concrete embodiments of the present disclosure are described below. In the following description, common or corresponding components are denoted by the same reference symbols.

### First Embodiment

### (1. Configuration of a Program Distribution System)

FIG. 1B is a block diagram illustrating the functional configuration of a program distribution system according to a first embodiment of the present disclosure. The program distribution system includes a host device (video recorder) 1, which functions as a distribution server, a agent distribution server (video recording center) 3, which functions as an agent server, and a plurality of information terminals (receiving terminals) 2A to 2N, which are connected to the video recorder 1 and the video recording center 3 via a wired or wireless network. The following description assumes that the plurality of receiving terminals 2A to 2N simultaneously receive the distribution of a set of broadcast program contents. In this embodiment, the receiving terminals 2A to 2N can play broadcast program contents after downloading the broadcast program contents from the video recorder 1 and saving the broadcast program contents.

The internal configuration of the video recorder 1 is described first. The video recorder 1 includes function blocks which are a program recording unit 11, a program management unit 12, a program converting unit 13, a program transmitting unit 14, a play use right granting unit 15, a distributee terminal authenticating unit 16, and the control unit 19. The program recording unit 11 has a function of receiving and recording broadcast programs of satellite broadcasting and ground-based broadcasting. The program management unit 12 manages a program recorded by the program recording unit 11 along with the encoding method and other types of information of the recorded program. The program converting unit 13 executes encoding conversion or other types of conversion of broadcast program data to suit the respective playing environments of the receiving terminals 2A to 2N. The program transmitting unit 14 transmits broadcast program converted by the program converting unit 13 to the receiving terminals 2A to 2N which are described later or to the video recording center 3. The play use right granting unit 15 manages for each recorded broadcast program the allotted use count (the total number of times that the recorded program can be played, dubbed, distributed over a network, and otherwise used). The distributee terminal authenticating unit 16 performs authentication for each of the receiving terminals 2A to 2N to determine whether or not a broadcast program can be distributed to the receiving terminal and obtains the playing environment information of the receiving terminals 2A to 2N. The control unit 19 is connected to the rest of the components via signal lines (not shown) to control the components by operations described later.

The function of the distribution instructing unit 18 of FIG. 1A is implemented by a combination of the program transmitting unit 14 and the play use right granting unit 15 in this embodiment. Specifically, the program transmitting unit 14 and the play use right granting unit 15 follow an instruction from the control unit 19 to distribute a recorded broadcast program directly to the receiving terminals 2A to 2N, or to instruct the video recording center 3 to distribute the recorded broadcast program. The play use right granting unit 15, which manages the allotted use count of contents, also functions as a use right management unit.

The internal configuration of the receiving terminals 2A to 2N is described next. The receiving terminals 2A to 2N which have the same configuration in this embodiment may be configured differently from one another as long as the receiving terminals 2A to 2N all include the following configuration.

A program receiving unit 21 receives the distribution of a broadcast program from the program transmitting unit 14 of the video recorder 1 or from a program transmitting unit 33 of the video recording center 3 which is described later. In the case of downloading a distributed broadcast program via a network, the program receiving unit 21 also has a function of recording the distributed broadcast program in a recording medium such as an HDD. A program playing unit 22 plays a broadcast program obtained by the program receiving unit 21. A play use right obtaining unit 23 obtains the play use right of a broadcast program in question from the play use right granting unit 15 of the video recorder 1 or from a surrogate play use right granting unit 34 of the video recording center 3 which is described later, and permits the program playing unit 22 to play the broadcast program.

An authentication processing unit 24 requests authentication in order to ask the video recorder 1 to distribute a recorded broadcast program, transmits playing environment information of its own terminal, and asks for the distribution of a desired broadcast program.

This system also has the video recording center 3. The video recording center 3 performs processing that surpasses the processing performance of the video recorder 1 (e.g., re-encoding processing and program transmitting processing), to thereby distribute a recorded broadcast program in place of the video recorder 1 while protecting copyright.

A program receiving unit 31 in the video recording center 3 receives a broadcast program to be distributed which is provided from the video recorder 1. A program converting unit 32 performs processing in place of the program converting unit 13 within the video recorder 1, such as re-encoding processing for encoding conversion of a broadcast program. The program transmitting unit 33 transmits a broadcast program to the receiving terminals 2A to 2N. A distributee terminal information obtaining unit 35 obtains playing environment information of the receiving terminals 2A to 2N from the distributee terminal authenticating unit 16 within the video recorder 1, and provides re-encoding information to the program converting unit 32. The surrogate play use right granting unit 34 gives a play use right to a receiving terminal to which a broadcast program is distributed in place of the play use right granting unit 15 within the video recorder 1. Those function units within the video recording center 3 in this embodiment cooperate with one another to have the functions of the surrogate distribution unit 39 of FIG. 1A. The surrogate play use right granting unit 34 which manages the play use count of contents also has functions of a use right management unit.

In each of the video recorder 1, the receiving terminals 2A to 2N, and the video recording center 3, the function units may be favorably implemented by a combination of a processor (e.g., a digital signal processor (DSP) or a central processing unit) provided in the video recorder, the receiving terminal, or the video recording center and software stored in a memory (not shown). Alternatively, the function units may be implemented by pieces of dedicated hardware that are configured to respectively execute the processing procedures described above.

Arrows in FIG. 1B indicate logical flows of information, and do not necessarily reflect the accurate physical connection states. For instance, the distribution server 10, the agent server 30, and the information terminal are connected to one another via wired or wireless input/output interfaces.

### (2. Processing Procedures of the Program Distribution System)

The processing procedures of the program distribution system according to this embodiment is described next.

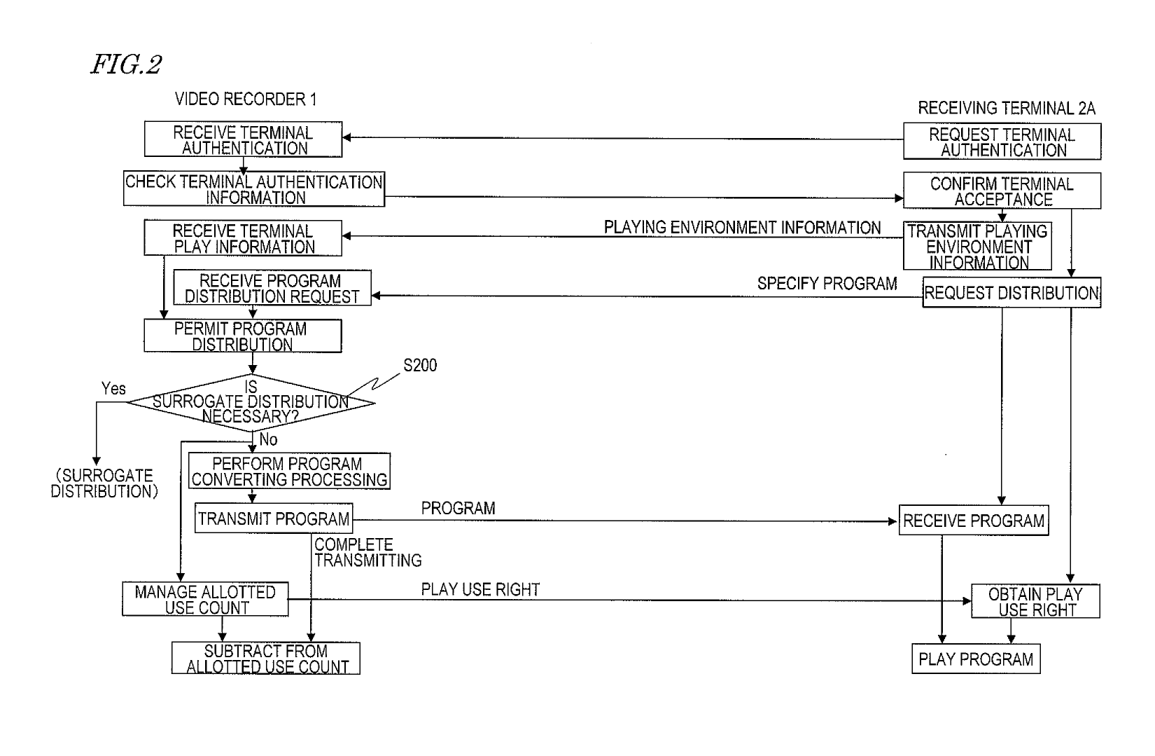

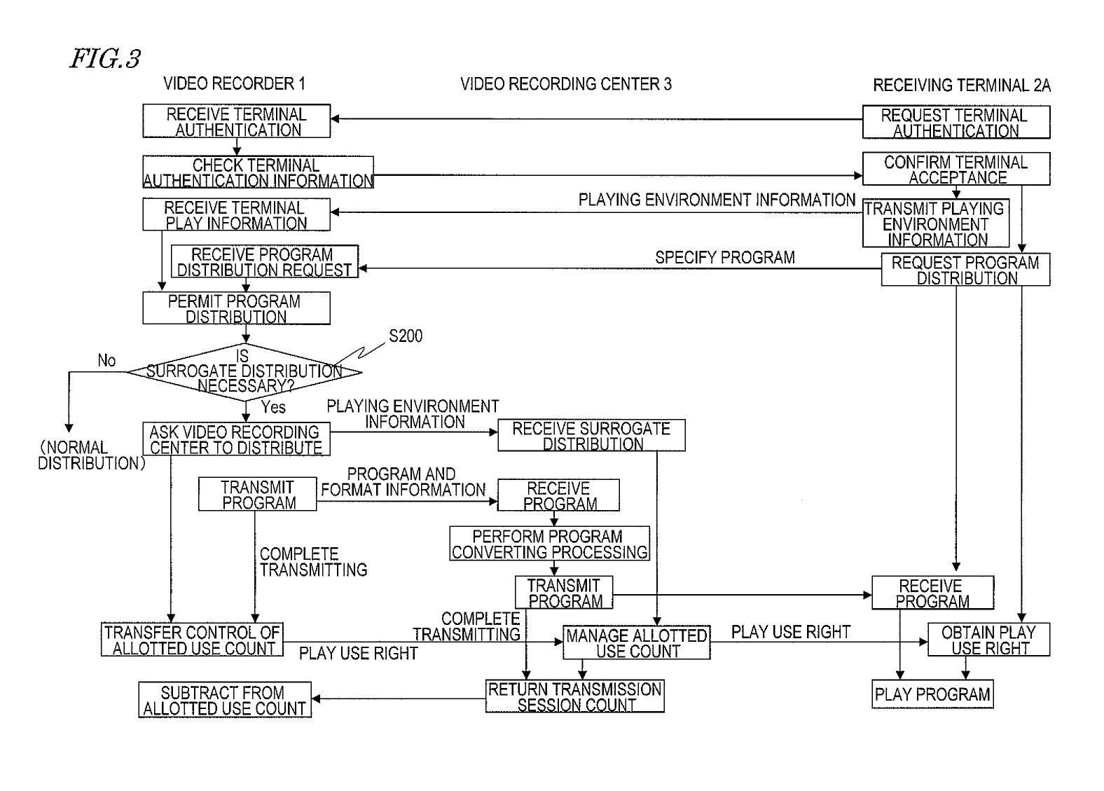

FIGS. 2 and 3 are processing procedure diagrams illustrating respective control procedures of the video recorder 1, the receiving terminal 2A, and the video recording center 3. FIG. 2 illustrates a procedure for a case where the video recorder 1 executes conversion processing and distributes a broadcast program, and FIG. 3 illustrates a case where the video recording center 3 executes conversion processing and distributes a broadcast program. A representative case where a broadcast program is distributed to the receiving terminal 2A is discussed here, but the same processing is executed to distribute a broadcast program to other receiving terminals.

To receive the distribution of a broadcast program from the video recorder 1, the receiving terminal 2A first issues a terminal authentication request from the authentication processing unit 24. The video recorder 1 performs authentication in the distributee terminal authenticating unit 16 to determine whether or not the terminal that has transmitted the terminal authentication request is allowed to receive distribution. This authentication can be carried out by, for example, registering the ID number, password, or the like of the receiving terminal 2A in the video recorder 1 in advance, requesting the receiving terminal 2A to enter a password or the like before distributing a broadcast program, and checking whether or not the entered password matches the registered one.

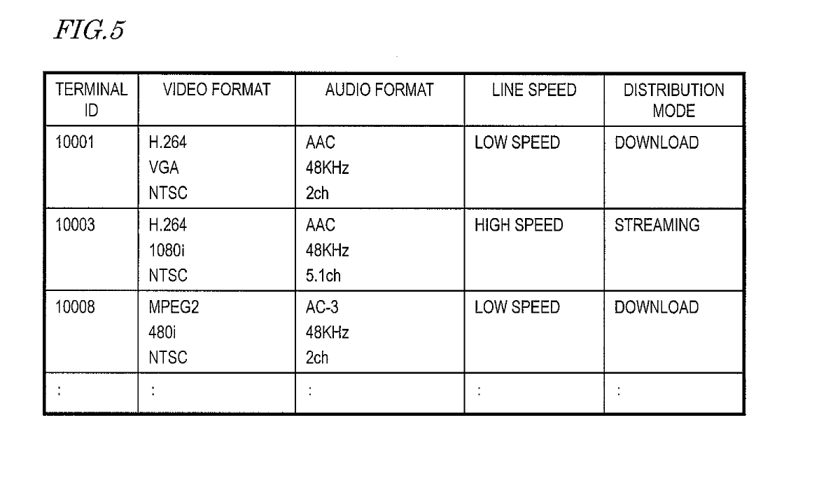

After the terminal authentication is finished, the receiving terminal 2A transmits its own playing environment information. The playing environment information may be registered in the video recorder 1 in advance, when the receiving terminal 2A is registered in the video recorder 1. However, when the environment of the receiving terminal 2A in which a broadcast program can be played is changed through software upload or the like, the receiving terminal 2A needs to transmit new playing environment information to the video recorder 1. The receiving terminal 2A in this embodiment therefore transmits its own playing environment information to the video recorder 1 when requesting distribution. The video recorder 1 obtains, as the playing environment information, information about an encoding method that can be played by the receiving terminal 2A, information about image resolution, information on a a communication band in which the receiving terminal 2A can receive data, and the like. Playing environment information is described later with reference to FIG. 5.

The receiving terminal 2A next specifies a broadcast program that the user wishes to receive through distribution, and requests the video recorder 1 to distribute the broadcast program. A broadcast program can be specified by, for example, selecting from distributable broadcast programs on a program list, which is transmitted from the video recorder 1.

The control unit 19 in the video recorder 1 receives the request to distribute the specified program and, based on the playing environment information of the receiving terminal 2A, determines whether encoding conversion or other types of conversion processing and distribution processing are to be executed in the video recorder 1 or the video recording center 3 (Step S200). This determination is made by considering the playing environment information of the distribution destination terminal and the load state of the video recorder 1 as well in a comprehensive manner.

The first part of the following description deals with processing for the case where the video recorder 1 executes contents data conversion processing and distribution processing, and the subsequent part of the following description deals with processing for the case where the video recording center 3 handles distribution in place of the video recorder 1.

(1) Case of Executing Conversion Processing and Distribution Processing in the Video Recorder 1

In the case where the control unit 19 determines that it is appropriate to execute conversion processing and distribution processing in the video recorder 1, the program converting unit 13 of the video recorder 1 executes conversion processing such as encoding conversion. The converted program is transmitted from the program transmitting unit 14 to the receiving terminal 2A. The processing procedure in this case is illustrated in FIG. 2.

An example of encoding conversion or other types of conversion processing is processing of converting the video encoding method or the audio encoding method. Processing of converting the video encoding method may convert, for example, MPEG2 to H.264. Processing of converting the audio encoding method may convert, for example, AAC to AC-3. Converting an encoding method requires decoding once a broadcast program that has been recorded in an encoded state, and re-encoding in an encoding format into which the broadcast program is to be converted. When at least one of the video encoding method and the audio encoding method needs to be converted, re-encoding for necessary encoding is executed. In the case where the image resolution of the receiving terminal 2A is low, the broadcast program needs to be re-encoded to suit the low resolution. In the case where the count of channels in which the receiving terminal 2A can play audio data and the sampling frequency of the receiving terminal 2A differ from those of the broadcast program, the broadcast program needs to be re-encoded to suit that environment. In the case where there is only a little room in the communication band to the receiving terminal 2A via a network, the quantity of signals transmitted to the receiving terminal 2A needs to be reduced and re-encoding is executed to enhance the compression ratio in encoding.

When it is determined based on the playing environment information transmitted from the receiving terminal 2A that the recorded broadcast program needs to be converted, the control unit 19 uses the program converting unit 13 to convert data of the broadcast program. The broadcast program converted in the program converting unit 13 is transmitted from the program transmitting unit 14. The transmitted broadcast program is received by the program receiving unit 21 in the receiving terminal 2A.

When the program receiving unit 21 finishes receiving the entire broadcast program specified by the user, the receiving terminal 2A transmits a reception completion notification to the video recorder 1. When receiving the notification, the play use right granting unit 15 of the video recorder 1 gives a program play use right for playing the broadcast program once to the play use right obtaining unit 23 of the receiving terminal 2A. The play use right obtaining unit 23 receives the program play use right and has the program playing unit 22 play the broadcast program received by the program receiving unit 21. The play use right granting unit 15 in the video recorder 1 subtracts the allotted use count of the broadcast program by 1 each time a program play use right is given with regards to the broadcast program. When the allotted use count reaches zero as a result of the subtraction, the video recorder 1 erases data of this recorded broadcast program so that the recorded broadcast program cannot be distributed from then on.

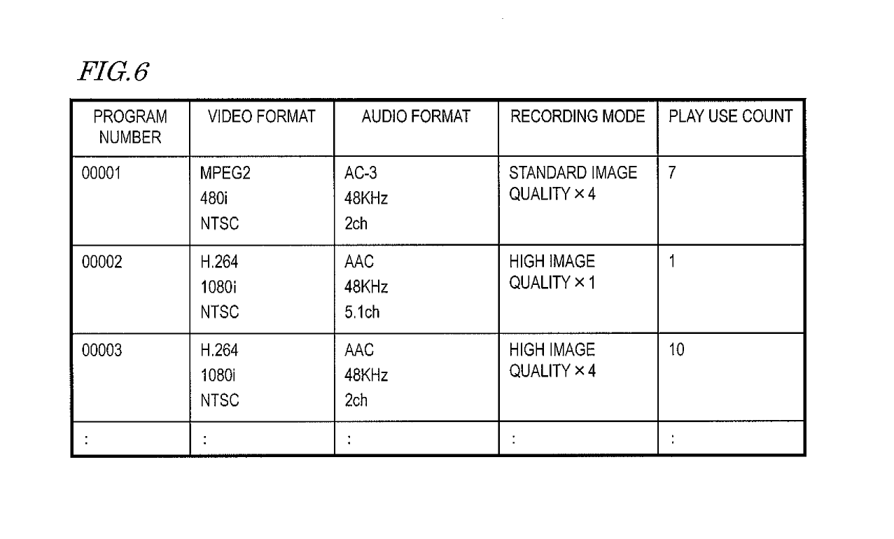

In the case where distribution requests are simultaneously issued to the video recorder 1 from a plurality of receiving terminals, the processing described above is executed in parallel, and the allotted use count is managed for each program. Details of the allotted use count management on a program-by-program basis are described later with reference to FIG. 6.

The configuration described above makes it possible to distribute a broadcast program to the receiving terminal 2A while protecting copyright, but has a problem in that, when there are an increased number of receiving terminals, contents cannot be distributed to all of the receiving terminals. Specifically, when there are more terminals to which a recorded broadcast program is to be distributed concurrently, the limited processing performance of the program converting unit 13 of the video recorder 1 and network limitations impede re-encoding output that meets all requests. The resultant problem is that some of the receiving terminals cannot receive the distribution of the recorded broadcast program.

For instance, while the same recorded broadcast program can be distributed concurrently to ten terminals at maximum in accordance with the operation rules of Dubbing 10, the number of terminals that can be used concurrently is limited due to limitations in the processing performance of the video recorder 1 and the like.

As a solution, the video recording center 3 which has high processing performance is newly provided in this embodiment to perform processing that surpasses the processing performance of the video recorder 1 (e.g., re-encoding processing and program transmitting processing). A program distribution system that is less limited in the number of terminals to which a broadcast program can be distributed while protecting copyright can thus be provided. Described below is processing for the case where conversion processing and distribution processing are executed in the video recording center 3.

(2) Case of Executing Conversion Processing and Distribution Processing in the Video Recording Center 3

A procedure for the case where the video recording center 3 executes conversion processing and distribution processing is illustrated in FIG. 3. The procedure of FIG. 3 is the same as the procedure of FIG. 2 up to and including Step S200, where the video recorder 1 executes processing of determining whether or not surrogate distribution is necessary after permitting program distribution in response to a request from the receiving terminal 2A. In the case where the control unit 19 determines that it is appropriate to execute conversion processing and distribution processing in the video recording center 3, the distributee terminal authenticating unit 16 transmits the playing environment information of the receiving terminal 2A to the distributee terminal information obtaining unit 35 in the video recording center 3. The program management unit 12 transmits data of the recorded broadcast program which has not been processed by encoding conversion or any other types of processing by the program converting unit 13 to the program transmitting unit 14, which transmits the data of the broadcast program to the program receiving unit 31 in the video recording center 3. When transmitting the data of the broadcast program, the program transmitting unit 14 also transmits format information of the broadcast program to the program receiving unit 31. The play use right of the broadcast program to be distributed is further transmitted by the play use right granting unit 15 to the surrogate play use right granting unit 34 in the video recording center 3.

The distributee terminal information obtaining unit obtains the playing environment information of the receiving terminal 2A, and the program receiving unit 31 receives the data of the recorded broadcast program to be distributed and the format information of the broadcast program. Based on the information obtained by the distributee terminal information obtaining unit 35, the program converting unit 32 executes conversion processing such as encoding conversion. The conversion processing in this case is the same as the one executed by the program converting unit 13 in the video recorder 1 which is described above, and a detailed description thereof is omitted here. At the time when the program transmitting unit 14 of the video recorder 1 transmits the broadcast program in order to perform program converting processing in the video recording center 3, the play use count of the broadcast program is not officially subtracted yet, and is just subtracted apparently as described later. The program play use count is officially updated after the video recording center 3 finishes transmitting the broadcast program to the receiving terminal 2A.

The broadcast program converted by the program converting unit 32 is transmitted from the program transmitting unit 33 to the program receiving unit 21 in the receiving terminal 2A. After finishing receiving the entire broadcast program specified, the program receiving unit 21 transmits a notification informing of reception completion to the video recording center 3. The video recording center 3 receives the notification and transmits a notification informing of transmission completion to the video recorder 1. When receiving the notification, the play use right granting unit 15 of the video recorder 1 gives a program play use right of the broadcast program to the surrogate play use right granting unit 34. The surrogate play use right granting unit 34 gives the program play use right to the play use right obtaining unit 23 in the receiving terminal 2A. The play use right obtaining unit 23 receives the program play use right, and then the program playing unit 22 plays the received broadcast program. The play use right granting unit 15 subtracts from the program play use count (allotted use count) a number that indicates how many times the surrogate play use right granting unit 34 has given a program play use right to the play use right obtaining unit 23. When the subtraction brings the program play use count to zero, the recorded broadcast program is deleted from the video recorder 1 and the video recording center 3 so that the recorded broadcast program cannot be distributed from then on.

In the case of managing the allotted use count by the program play use right as described above, the processing of subtracting from the play use count of a broadcast program is executed when the transmitting of the broadcast program is completed, whereas the control of the play use count is transferred when the video recorder 1 gives a program play use right to the video recording center 3. Specifically, the video recorder 1 apparently subtracts 1 from a play use count managed by the video recorder 1, as an indication of being “in the process of distributing once”, at the time when a program play use right is given to the video recording center once. Upon receiving a notification from the video recording center 3 to the effect that data transfer to the receiving terminal is complete, the video recorder 1 officially subtracts from the play use count. This is because, if the system is designed to subtract from the play use count for the first time when the notification informing the completion of data transfer to the receiving terminal is received from the video recording center 3 and many other receiving terminals ask for distribution without waiting for the completion of data transfer to the receiving terminal in question, the video recorder 1 ends up permitting distribution more times than the play use count. This problem is noticeable particularly when the amount of data transferred to the receiving terminal is large and the receiving terminal is significantly limited in transmission rate at which the receiving terminal can receive, or when the bandwidth of the transmission path is narrow for the large amount of data being transferred. In such cases, the transfer of a broadcast program takes time to complete and, if the play use count of the broadcast program has not been subtracted despite the fact that the broadcast program is being distributed to other terminals, the video recorder 1 may indefinitely give permission to play to a plurality of other terminals from which distribution requests are received substantially simultaneously. The apparent play use count and the actual play use count are therefore managed separately in this embodiment.

Another reason for subtracting from the play use count officially when notified from the video recording center 3 of the completion of data transfer to the receiving terminal is that, this way, a broadcast program can be distributed again in the event that the data transfer is interrupted as a result of a failure in the receiving terminal, heavy traffic in the network line, and the like. Specifically, in such cases, the transfer is not regarded as complete and, when the same receiving terminals issues a request to distribute the same broadcast program again, the previously given play use right is treated as still valid and is excluded from subtraction targets until the transfer is finished.

In the case where the entirety of a distributed broadcast program cannot be recorded in a memory (storage area) of the receiving terminal, the system may be designed to subtract from the allotted use count only when the broadcast program is distributed initially and to restrain from decrementing the program play use count in the case where the distribution is resumed from the middle of the broadcast program or other similar cases as long as the same broadcast program is distributed to the same terminal.

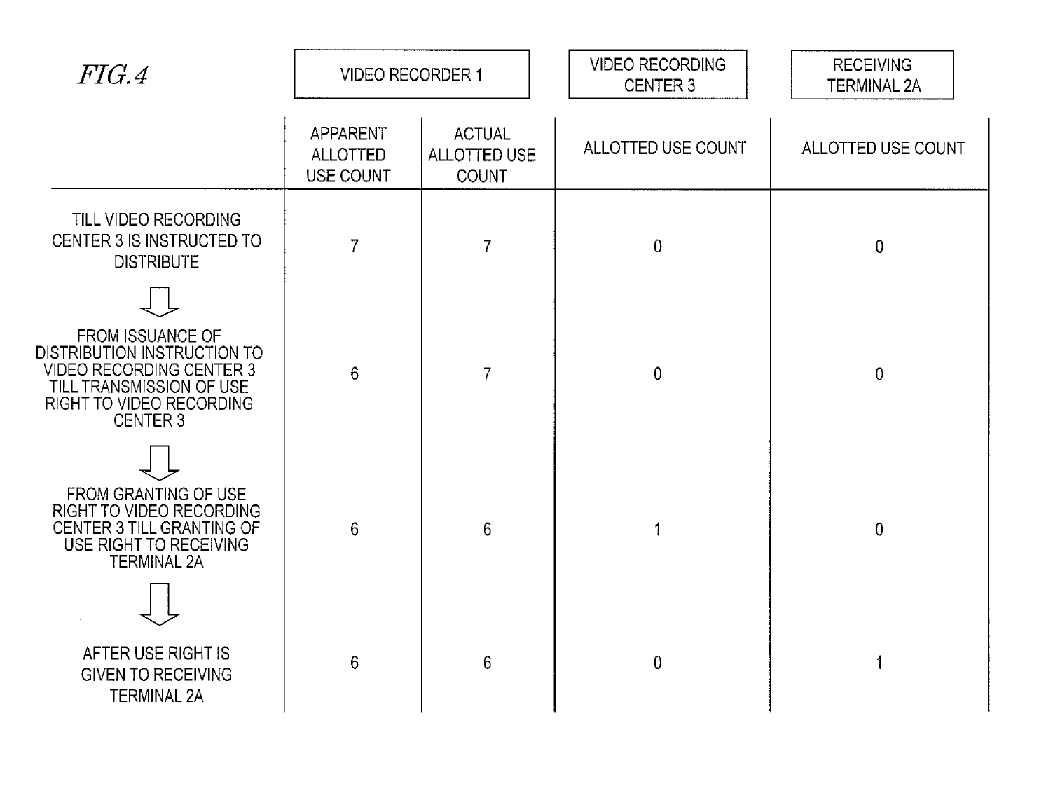

FIG. 4 is a diagram illustrating an example of changes in the allotted use count of a broadcast program. This example assumes that the remaining allotted use count of the distribution target broadcast program is set to “7” until the video recording center 3 is instructed to distribute, and that the allotted use count of the broadcast program is “0” in the video recording center 3 and the receiving terminal 2A, in other words, the video recording center 3 and the receiving terminal 2A do not have the use right. When a distribution instruction is issued to the video recording center 3 in this state, the video recorder 1 does not subtract from the actual allotted use count but subtracts the apparent allotted use count of the distribution target broadcast program by “1” to obtain “6”. When a program play use right is subsequently transmitted to the video recording center 3, the surrogate play use right granting unit 34 of the video recording center 3 increases the allotted use count of the broadcast program to “1”. This indicates that obtaining the program play use right has increased the allotted use count in the video recording center 3 by “1”. The surrogate play use right granting unit 34 then gives the program play use right to the receiving terminal 2A, thereby returning the allotted use count in the video recording center 3 to “0” and increasing the allotted use count in the receiving terminal 2A to “1”. The receiving terminal 2A can thus play the broadcast program.

While FIG. 4 is an example of the case where the use right of a broadcast program is given only to one receiving terminal 2A to distribute the broadcast program just to the receiving terminal 2A, the same management is executed also when distribution requests are simultaneously issued from a plurality of receiving terminals. To give an example, after the state of FIG. 4, three more receiving terminals ask for the distribution of the same broadcast program and the video recorder 1 determines that the broadcast program is to be distributed via the video recording center 3 to those receiving terminals as well. The video recorder 1 in this case issues an instruction to the video recording center 3 to distribute to three terminals, and subtracts the apparent allotted use count by “3”. The video recorder 1 then gives use rights for three terminals to the video recording center 3. As a result, the allotted use count of the broadcast program in the video recording center 3 increases to “3”. The use rights are then given from the video recording center 3 to the respective receiving terminals, with the result that the allotted use count in the video recording center 3 is sequentially subtracted and returns to whereas the allotted use count in each receiving terminal to which the broadcast program is distributed increases to “1”. The three receiving terminals can thus play the broadcast program.

In this manner, the video recorder 1 and the video recording center 3 change the allotted use count each time a play use right is given/received so as to make the allotted use count consistent for each broadcast program. This control keeps the sum of the allotted use counts in the video recorder 1, the video recording center 3, and the respective receiving terminals always at a given value for each set of contents.

The procedure from the authentication of the plurality of receiving terminals 2A to 2N by one video recorder 1 to distribution from one video recorder 1 to the plurality of receiving terminals 2A to 2N is controlled separately for each receiving terminal in this embodiment. The video recorder 1 and the video recording center 3 are each capable of executing processing of distributing to the plurality of receiving terminals 2A to 2N concurrently.

As described above, the video recording center 3 is provided in this embodiment so that the program converting unit 32 of the video recording center 3 performs processing that surpasses the processing performance of the video recorder 1 (e.g., re-encoding processing and program transmitting processing). The program distribution system provided as a result is capable of distributing a recorded broadcast program in place of the video recorder 1 while protecting copyright with a program play use right. In the case where there is more program distribution than one video recording center 3 can handle as a result of an increase in the number of program distribution, the number of video recording centers may be increased to increase surrogate distribution.

The very recorded broadcast program in the video recorder 1 which is being distributed is deleted during the distribution in some cases, such as a case of deleting recorded broadcast programs due to the limited capacity of the HDD, or a case of deleting a recorded broadcast program that a user does not want to be distributed. In such cases, the removal of contents data of the broadcast program in question from the program management unit 12 stops the transmitting of the broadcast program from the program transmitting unit 14. The play use right that has been given to the surrogate play use right granting unit 34 from the play use right granting unit 15 is forfeited. In the case where the entire broadcast program has already been transmitted to the video recording center 3, the play use right granting unit 15 issues a play use right forfeiting instruction to the surrogate play use right granting unit 34, to thereby stop the transmission of the broadcast program from the program transmitting unit 33 of the video recording center 3.

When the play use right is forfeited and the broadcast program can no longer be received, the receiving terminal 2A may display, on a display device attached to the terminal or the like, a message informing that the playing of the recorded broadcast program that is being distributed is stopped due to the deletion of the recorded broadcast program.

### (3. Configuration Example of Playing Environment Information of a Receiving Terminal)

An example of concrete details of playing environment information of a receiving terminal is described next.

FIG. 5 is a diagram illustrating a configuration example of playing environment information of a receiving terminal. The distributee terminal authenticating unit 16 within the video recorder 1 manages the playing environment information. The playing environment information includes, for example, an identifier which is assigned to each terminal (a terminal ID), visual encoding information and audio encoding information about encoding methods that can be played by the terminal, image resolution information about an image resolution that can be played by the terminal, an audio channel count, a sampling frequency, playing method information indicating which of NTSC, PAL, and the like is used, line speed information about a line speed at which the terminal can receive data, a distribution mode in which the terminal can receive a broadcast program, and security code information (not shown). Methods that can be defined as the distribution mode include a downloading method in which the playing of a broadcast program is started once the main body of the broadcast program is received in a recording medium on the receiving terminal side, and a streaming method in which a broadcast program to be played is divided into sections and a necessary section is obtained as the need arises.

The distributee terminal authenticating unit 16 receives playing environment information from each receiving terminal, and adds the received information to a table as the one illustrated in FIG. 5. The program converting unit 13 converts broadcast program data into a suitable format based on this information. Similarly, in surrogate distribution, the playing environment information is transmitted to the video recording center 3, where the program converting unit converts broadcast program data into a suitable format based on the playing environment information.

### (4. Configuration Example of Recorded Program Information)

FIG. 6 is a diagram illustrating a configuration example of recorded program information. The recorded program information includes program information of each program that is recorded by the program recording unit 11 and managed by the program management unit 12, and information about the program play use count which is managed in association with the program information. A program number is assigned to each broadcast program, and the recorded program information may store visual encoding and audio encoding information of the broadcast program, image resolution information thereof, an audio channel count, a sampling frequency, playing method information indicating which of NTSC, PAL, and the like is used, etc.

The video recorder 1 may record a broadcast program on an HDD or the like as it is, without performing encoding conversion. However, re-encoding such as compression encoding is executed so that more broadcast programs can be recorded in the limited capacity of the HDD. In order to dub and save a recorded broadcast program on a recording medium such as a DVD or a BD, the broadcast program data is also recorded in a format suitable for the recording medium which is obtained by compression encoding. The recorded program information in the example of FIG. 6 therefore includes information about the encoding methods for a broadcast program recorded in the HDD. The recorded program information may also store information about whether the recorded broadcast program has standard image quality in which the vertical resolution is 480 lines as in the NTSC method or high image quality in which the vertical resolution is 1,080 lines, and information indicating the compression ratio.

The program information also manages information about the program play use count which is subtracted when the broadcast program is dubbed to a recording medium and distributed to a receiving terminal. A broadcast program allotted a program play use right that allows the broadcast program to be used ten times or less in accordance with the mechanism of Dubbing 10 in Japan, a broadcast program alotted a program play use right that allows the broadcast program to be used only once, a broadcast program that has no restrictions in program play use count, and the like are managed based on the program play use count information.

When a new broadcast program is recorded, the program management unit 12 adds information of the broadcast program to a table as the one illustrated in FIG. 6. For example, the play use count is set to “10” by default in the case where the method of Dubbing 10 is followed. Contents whose play use count is restricted to one are set to “1” as the default of the play use count. In the case where the broadcast program is distributed to a receiving terminal, the play use count of the broadcast program is subtracted by 1 each time. Information of the broadcast program is deleted from the table when the play use count reaches zero. The play use count illustrated in FIG. 6 is managed by the play use right granting unit 15.

### (5. Reference for Determining Whether to Ask the Video Recording Center to Perform Surrogate Distribution)

An example of a reference for determining whether to ask the video recording center 3 to perform surrogate distribution is described next.

The video recording center 3 is not always necessary, as when the program distribution system includes one video recorder and one receiving terminal and the communication band is sufficiently wide. However, the video recording center needs to be installed particularly when the following conditions are met.

(1) When the Distribution Session Count of the Distribution of a Broadcast Program to Receiving Terminals Exceeds the Processing Performance of the Program Converting Unit 13 within the Video Recorder 1

The number of program conversions that can be performed concurrently is determined by the computing power of a digital signal processor (DSP), a CPU, or a signal processing circuit that is necessary for decoding and encoding for encoding conversion, and by limitations in, among others, the capacity of a memory for storing image and audio data that is necessary for the conversion. It is therefore effective to have the video recording center 3 execute program conversion and handle distribution in place of the video recorder 1 when there are more sessions for distributing a broadcast program to receiving terminals than can be processed by the program converting unit 13.

(2) When the Amount of Data Distributed from the Video Recorder 1 Exceeds the Ability of the Network Band to Distribute Concurrently with the Use of a Network Line

In some cases, the amount of data that can be distributed from one video recorder 1 is limited even when the number of program conversions is low, as in the case where a plurality of receiving terminals have the same playing environment information (encoding information, image resolution, and the like). For instance, when receiving terminals have the same playing environment information as in the case where the receiving terminals are information terminals manufactured by the same maker and having the same version, the video recorder 1 can prepare a broadcast program to be distributed by performing re-encoding processing geared to one receiving terminal. However, in the case transferring data of a plurality of broadcast programs to a plurality of receiving terminals, the video recorder 1 may fail to distribute to the receiving terminals due to limitations in the transmission performance of the video recorder 1 and limitations in transmission band (including heavy traffic). For example, when a LAN terminal of the video recorder 1 has a data transfer rate of 100 Mbps at maximum and continuous transmission of one broadcast program without a break requires 25 Mbps, the video recorder 1 can transmit four broadcast programs at most. When a LAN terminal of the video recording center 3 has a transfer rate of 1 Gbps at maximum, a larger amount of data can be distributed. Then, the amount of data transmitted from the video recorder 1 can be kept small by distributing to a plurality of receiving terminals from the video recording center 3 in place of the video recorder 1.

(3) When the Video Recorder 1 is Programmed to Record a Broadcast Program and the Programmed Recording is Given Priority Over Distribution

In the case where a DPS or other processors are expected to perform decoding and encoding signal processing for encoding conversion for the programmed recording of the broadcast program, there is a possibility that the program converting unit 32 cannot be used for program distribution. In such cases, program converting processing and distribution processing can be executed without delay by giving priority to the recording of the broadcast program and by letting the video recording center 3 handle distribution in place of the video recorder 1.

The control unit 19 determines whether or not to execute surrogate distribution by the video recording center 3 based on the determination references (1) to (3) described above.

(6. Devices that can be Proxies for the Video Recording Center 3)

The description given above assumes that a dedicated device that handles program distribution in place of the video recorder 1 is installed as the video recording center 3. Alternatively, another video recorder installed in a house where the main body of the video recorder 1 is placed may be an agent for the video recording center 3. By connecting the video recorders to each other via a wired or wireless network, a system is built in which, when one of the video recorders is programmed to record a broadcast program and is asked to distribute whereas the other video recorder is not programmed to record a broadcast program, the other video recorder handles processing of the program converting unit 13 and the like in place of the one video recorder. This configuration can be set so that one of the video recorders functions as a distribution server in some times whereas the other video recorder functions as an agent server, and so that the roles are reversed in other times by letting the one video recorder function as an agent server and the other video recorder function as a distribution server.

While it is assumed in this embodiment that the program recording unit 11 distributes a recorded broadcast program, distributed contents do not need to be a recorded broadcast program. The system can distribute any contents as long as the use count of the contents is restricted by copyright. For example, the system may distribute contents downloaded from the Internet or contents recorded on a recording medium such as a DVD or a BD.

Another assumption of this embodiment is that the system employs a mode in which the video recorder 1 distributes contents in response to distribution requests from the receiving terminals 2A to 2N. Alternatively, the video recorder 1 may be configured so as to distribute contents voluntarily to a specific information terminal. It is sufficient if the control unit 19 is configured in this case, too, so as to determine whether or not to execute surrogate distribution based on at least one of the load state of the video recorder 1 itself and the load state of a network between the video recorder 1 and the receiving terminal.

### Second Embodiment

A program distribution system according to a second embodiment of the present disclosure is described next. The first embodiment assumes that a broadcast program is downloaded onto a recording medium inside the receiving terminal or the like. The second embodiment discusses a case where a broadcast program is distributed by streaming by reading and playing sections of the broadcast program as the need arises instead of recording the entire broadcast program in the receiving terminal. The following description focuses on differences from the first embodiment, and descriptions of matters common to the first and second embodiments are omitted here.

### (7. Processing Procedure of the Program Distribution System for the Case of Streaming Play)

The system in this embodiment can be implemented by the same configuration as in FIG. 1B. Descriptions of components that constitute the system are therefore omitted here.

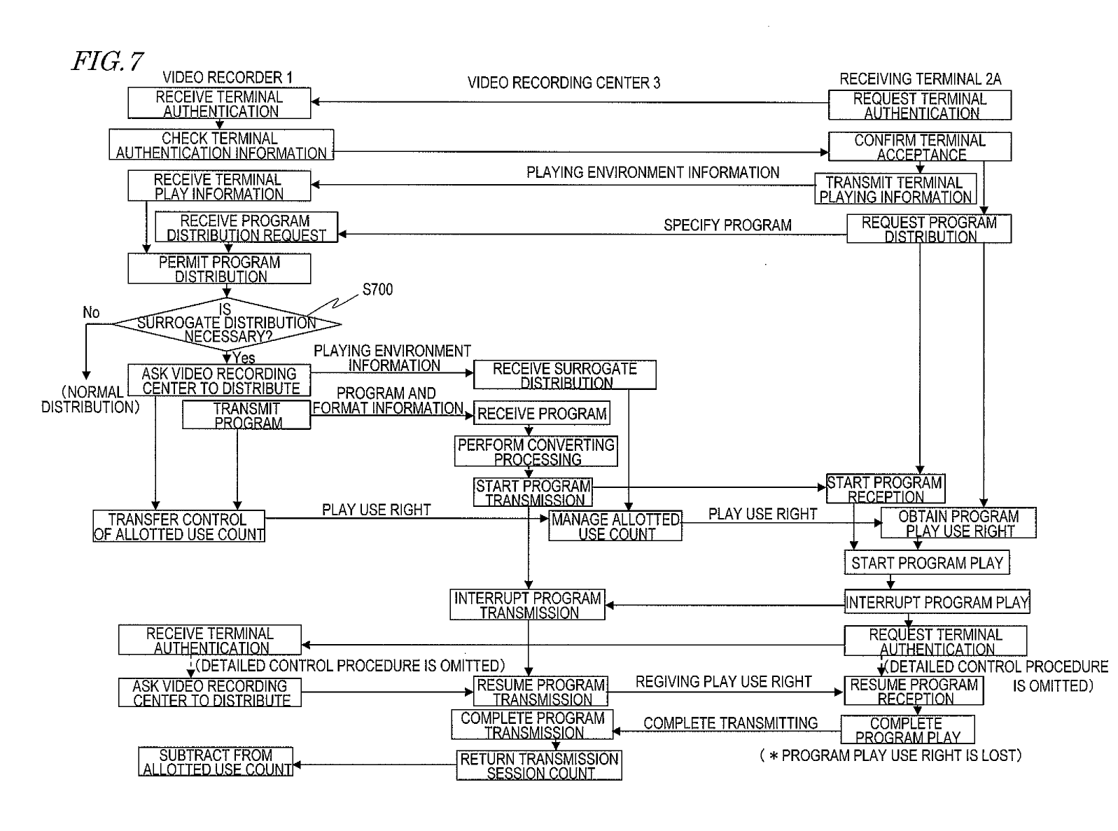

FIG. 7 is a processing procedure diagram illustrating respective control procedures of the video recorder 1, the receiving terminal 2A, and the video recording center 3 that are for the case of streaming play. The description here also takes as an example a case where a broadcast program is distributed to the receiving terminal 2A, but the same processing procedure is employed also in distribution to the rest of the receiving terminals, that is, the receiving terminals 2B to 2N. The receiving terminal 2A undergoes the same authentication procedure as in FIG. 3 before receiving program distribution from the video recorder 1. The distributee terminal authenticating unit 16 performs authentication to determine whether or not the terminal is allowed to receive distribution in response to a terminal authentication request from the authentication processing unit 24. After the authentication, the video recorder 1 obtains playing environment information of the receiving terminal 2A which includes encoding information, image resolution information, and communication band information about a communication band in which the receiving terminal can receive.

The receiving terminal 2A next specifies broadcast program that the user wishes to receive through distribution. This is accomplished by, for example, selecting from distributable broadcast programs on a program list transmitted from the video recorder 1 as in the first embodiment. The distributee terminal authenticating unit 16 in the video recorder 1 receives a request to distribute the specified broadcast program, and determines whether to execute encoding conversion or other types of conversion processing and distribution processing in the video recorder 1 or in the video recording center 3 based on the playing environment information of the receiving terminal 2A (Step S700).

When determining that it is appropriate to execute the conversion processing and the distribution processing in the video recording center 3, the distributee terminal authenticating unit 16 transmits the playing environment information of the receiving terminal 2A to the distributee terminal information obtaining unit 35. The program management unit 12 transmits data of the recorded broadcast program to the program transmitting unit 14 without a stop at the program converting unit 13. The program transmitting unit 14 transmits the data of the recorded broadcast program to the program receiving unit 31 in the video recording center 3. When transmitting the broadcast program data, the program transmitting unit 14 also transmits format information of the broadcast program to the program receiving unit 31. The play use right of the broadcast program to be distributed is further transmitted by the play use right granting unit 15 to the surrogate play use right granting unit 34 in the video recording center 3.

The distributee terminal information obtaining unit in the video recording center 3 obtains the playing environment information of the receiving terminal 2A, and the program receiving unit 31 receives the data of the recorded broadcast program to be distributed and the format information of the broadcast program. Based on the information obtained by the distributee terminal information obtaining unit 35, the program converting unit 32 executes conversion processing such as encoding conversion. The conversion processing in this case is the same as the one in the system of FIG. 1B, and a detailed description thereof is omitted here. At the time when the program transmitting unit 14 of the video recorder 1 transmits the broadcast program in order to perform program converting processing in the video recording center 3, the play use count of the broadcast program is not updated yet. The program play use count is not updated until the video recording center 3 finishes transmitting the broadcast program to the receiving terminal 2A.

The broadcast program converted by the program converting unit 32 is transmitted from the program transmitting unit 33 to the program receiving unit 21 in the receiving terminal 2A. When the program receiving unit 21 starts receiving, the play use right granting unit 15 gives the program play use right of the broadcast program to the surrogate play use right granting unit 34. The surrogate play use right granting unit 34 gives the program play use right to the play use right obtaining unit 23 in the receiving terminal 2A. When the play use right obtaining unit 23 receives the program play use right, the program playing unit 22 plays the received broadcast program.

Unlike the first embodiment where a broadcast program is played after downloaded, a broadcast program that is played by streaming is not recorded on a recording medium inside the receiving terminal 2A in its entirety. Depending on which scene is used, the user may interrupt the playing of the broadcast program or power off the terminal while the broadcast program is being played. When wishing to play the same broadcast program from the subsequent scene, the user needs to start all over from authentication in order to apply for the distribution again. In the case where the video recorder 1 recognizes the same receiving terminal 2A and the user wishes to start playing the same broadcast program from the subsequent scene, subtracting the play use count by 1 for each connection session possibly causes the user to use up fast the allotment of, for example, ten times set by restrictions, thereby making the broadcast program unavailable for viewing before the user can watch the end of the broadcast program. The user's frustration mounts if streaming is interrupted many times due to matters of network lines or the battery capacity of the receiving terminal.

As a solution, when receiving a request for terminal authentication and program distribution, the distributee terminal authenticating unit 16 in this embodiment determines whether or not the request is to resume playing with respect to previous distribution that has been incomplete. When it is determined that the distribution request is a request to resume playing, the video recorder 1 instructs the video recording center 3 to resume the distribution. The surrogate play use right granting unit 34 receives the instruction, grants the program play use right to the receiving terminal 2A again in order to continue the playing from the last time, and resumes the distribution of the broadcast program. The receiving terminal 2A uses the program play use right granted again to resume playing the broadcast program from some point in the broadcast program. This program playing is ended when the distribution of the end of the broadcast program is received or when the user performs an operation for stopping the playing of the broadcast program (an operation indicating that the user no longer needs the broadcast program to be played). The receiving terminal 2A loses the program play use right of the broadcast program when the playing of the broadcast program is completed or stopped. When the video recording center 3 receives information indicating that the playing has been completed or stopped from the receiving terminal 2A, the video recording center 3 and the video recorder 1 execute program transmission completion processing. At this point, the play use right granting unit 15 subtracts from the program play use count of the broadcast program a number indicating how many times the program play use right is given to the surrogate play use right granting unit 34. When the program play use count reaches zero as a result of the subtraction, the recorded broadcast program is deleted from the video recorder 1 and the video recording center 3 so that the recorded broadcast program cannot be distributed from then on.

As described above, the video recorder 1 in this embodiment instructs the video recording center 3 to perform surrogate distribution in response to a streaming distribution request from a receiving terminal. Then, in the case where the receiving terminal requests again to play the broadcast program after an interruption to the distribution, the distribution is resumed without reducing the program play use count. Managing the system in this manner solves the inconvenience of losing the play use right due to an interruption that occurs before the distribution is completed.

The systems described in the first and second embodiments execute downloading and streaming independently as main methods of distribution to receiving terminals. Alternatively, distribution by downloading and distribution by streaming may be used simultaneously in combination.

### Third Embodiment

A program distribution system according to a third embodiment is described next. The system in the first embodiment converts a broadcast program recorded in the video recorder 1 and distributes the converted broadcast program to the receiving terminal 2A. This embodiment differs from the first embodiment in that the video recording center 3 holds the same broadcast program that is recorded in the video recorder 1 so that the broadcast program held in the video recording center 3 is distributed to the receiving terminal instead of distributing the broadcast program from the main body of the video recorder 1 via the video recording center 3. The following description focuses on differences from the first embodiment, and descriptions on matters common to the first embodiment and the third embodiment are omitted here.

### (8. Another Configuration Example of the Program Distribution System)

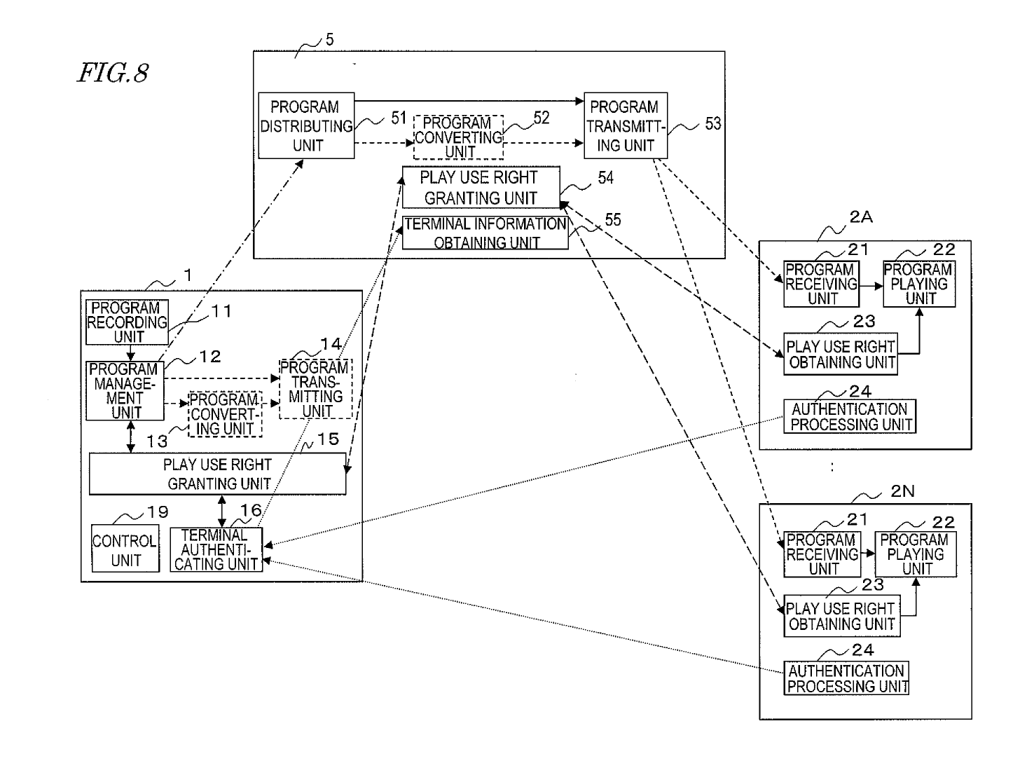

FIG. 8 is a block diagram illustrating the configuration of the program distribution system according to this embodiment. The program distribution system includes the video recorder 1, a video recording center 5, which is a server of a distribution service provider, and the plurality of receiving terminals 2A to 2N, which are connected to the video recorder 1 and the video recording center 5 via a network. The following description assumes that the plurality of receiving terminals 2A to 2N simultaneously receive distribution.

The internal configuration of the video recorder 1 is described first. The program recording unit 11 has a function of recording a broadcast program that is distributed from the video recording center 5 which is a distribution service provider via the network, for example. The program management unit 12 manages a broadcast program recorded by the program recording unit 11 along with the encoding method and other types of information of the broadcast program. The program converting unit 13 executes encoding conversion of program data or other conversions that suit the playing environment of the receiving terminals 2A to 2N. The program transmitting unit 14 transmits a broadcast program converted by the program converting unit 13. The play use right granting unit 15 manages the allotted play count for each recorded broadcast program to manage the number of times the broadcast program can be dubbed and distributed over a network. The distributee terminal authenticating unit 16 performs authentication to determine for each of the receiving terminals 2A to 2N whether or not the terminal is allowed to receive distribution, and obtains playing environment information of the receiving terminal.

The configuration of the receiving terminals 2A to 2N is described next. The authentication processing unit 24 requests authentication in order to ask the video recorder 1 to distribute a recorded broadcast program, transmits playing environment information of its own terminal, and requests to distribute a desired broadcast program. The program receiving unit 21 receives the distribution of a broadcast program from the program transmitting unit 14 of the video recorder 1, or from a program transmitting unit 53 of the video recording center 5. In the case where a distributed broadcast program is downloaded via a network, the program receiving unit 21 also has a function of recording the distributed broadcast program in a recording medium such as an HDD. The program playing unit 22 plays a broadcast program obtained by the program receiving unit 21. The play use right obtaining unit 23 obtains the play use right of a broadcast program in question, and permits the program playing unit 22 to play the broadcast program.

This system also has the video recording center 5 which has provided a broadcast program to the video recorder 1. The video recording center 5 which is a server of a distribution service provider has the original of a broadcast program provided to the video recorder 1. In the case where the volume of processing required for the program converting processing by the program converting unit 13 or the transmitting processing by the program transmitting processing unit 14 exceeds an acceptable value when a broadcast program is distributed along with a program play use right to the receiving terminals 2A to 2N, the video recorder 1 asks the video recording center 5 to handle distribution in place of the video recorder 1. The video recording center 5 receives the program play use right from the video recorder 1 to execute the processing of re-encoding the broadcast program and the processing of transmitting the broadcast program to the receiving terminals. In distributing a broadcast program to the receiving terminals, the video recording center 5 also gives the program play use right of the broadcast program to the receiving terminals, and can thus distribute a recorded broadcast program in place of the video recorder 1 while protecting copyright.

A program distribution unit 51 within the video recording center 5 distributes a broadcast program that is recorded in the video recorder 1 and whose program play use right is in the video recorder 1, in place of the video recorder 1. A program converting unit 52 performs, among others, re-encoding processing for encoding conversion of a broadcast program. The program transmitting unit 53 transmits a broadcast program to the receiving terminals 2A to 2N. A distributee terminal information obtaining unit 55 obtains playing environment information of the receiving terminals 2A to 2N from the distributee terminal authenticating unit 16 within the video recorder 1, and provides re-encoding information to the program converting unit 52. A surrogate play use right granting unit 54 distributes a broadcast program to the receiving terminals 2A to 2N, and gives a play use right to the receiving terminals in place of the play use right granting unit 15 within the video recorder 1.

### (9. Processing Procedure of the Program Distribution System for Distributing a Broadcast Program Inside the Video Recording Center)

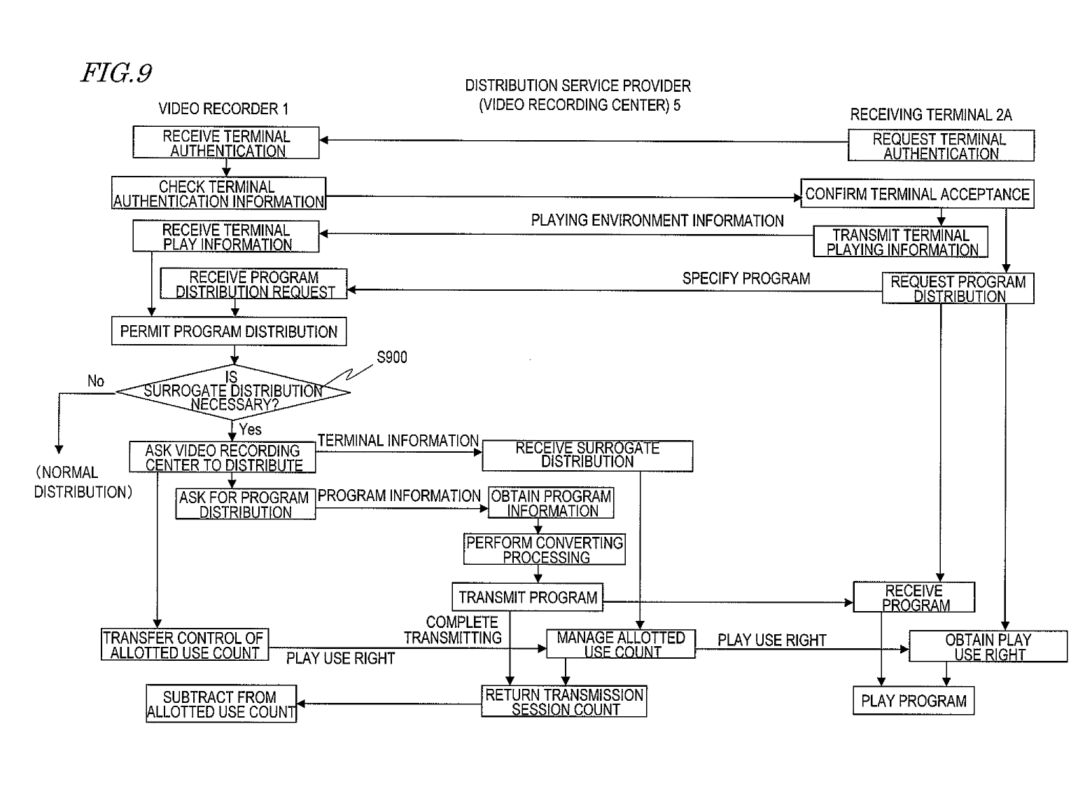

FIG. 9 is a processing procedure diagram illustrating respective control procedures of the video recorder 1, the receiving terminal 2A, and the video recording center 5. The description here also takes as an example a case where a broadcast program is distributed to the receiving terminal 2A, but the same processing procedure is employed also in distribution to other receiving terminals. When the receiving terminal 2A receives the distribution of a broadcast program from the video recorder 1, the same authentication procedure as in FIG. 3 is executed. The distributee terminal authenticating unit 16 performs authentication to determine whether or not the terminal is allowed to receive distribution in response to a terminal authentication request from the authentication processing unit 24. After the authentication, the video recorder 1 obtains playing environment information of the receiving terminal 2A, which includes information about an encoding method that can be played by the receiving terminal 2A, image resolution information, and communication band information about a communication band in which the receiving terminal can receive data.

The receiving terminal 2A next specifies a broadcast program that the user wishes to receive through distribution. Specifying a broadcast program to be distributed is accomplished by the user by selecting from distributable broadcast programs on a program list transmitted from the video recorder 1 as in the first and second embodiments. The distributee terminal authenticating unit 16 in the video recorder 1 receives a request distribute the specified broadcast program, and determines whether to execute encoding conversion or other types conversion processing in the video recorder 1 or in the video recording center 5 based on the playing environment information of the receiving terminal 2A (Step S900). Determining that it is appropriate to execute the conversion processing in the video recording center 5, the distributee terminal authenticating unit 16 transmits the playing environment information of the receiving terminal 2A to the distributee terminal information obtaining unit 55.

The video recording center 5 receives from the video recorder 1 the playing environment information of the receiving terminal 2A and program information to be distributed. In this embodiment, the program management unit 12 is configured to transmit distributed program information along with a program play use right to the program distribution unit 51 within the video recording center 5. The distributed broadcast program is managed in a program management table which is managed by the program management unit 12 within the video recorder 1. As illustrated in FIG. 6, a broadcast program to be distributed is managed by being paired with program play use count information. The program distribution unit 51 checks program information that is transmitted from the program management unit 12, and determines whether or not the transmitted information matches a broadcast program held in itself in order to determine whether to distribute from the program distribution unit 51. Determining that program information is a match, the video recording center 5 executes surrogate distribution. The video recording center 5 needs to be capable of confirming that a broadcast program held in itself matches a broadcast program to be distributed. Therefore, information for identifying a distributed broadcast program, such as a distribution service provider name, a program name, a program ID number, the length of recording time, or the like may additionally be registered as program information managed by the program management unit 12.

The video recording center 5 checks program information received from the video recorder 1 and, in the case where the program play use right of the broadcast program to be distributed remains, distributes the same broadcast program that is held in itself. The program converting unit 52 executes conversion processing such as encoding conversion based on information that is obtained from the distributee terminal information obtaining unit 55. The conversion processing here is the same as the processing executed in the system of FIG. 1B, and a detailed description thereof is omitted here. The program play use right count is not changed until the program converting processing by the video recording center 5 and the transmitting of the broadcast program from the video recording center 5 to the receiving terminal 2A are completed.

The broadcast program converted by the program converting unit 52 is transmitted from the program transmitting unit 53 to the program receiving unit 21 in the receiving terminal 2A. After the program receiving unit 21 finishes receiving the entire broadcast program specified, the surrogate play use right granting unit 54 receives from the play use right granting unit 15 a program play use right as many times as the number of times the broadcast program has been distributed. The surrogate play use right granting unit 54 gives one program play use right to the play use right obtaining unit 23 of the receiving terminal 2A. When the play use right obtaining unit 23 receives the program play use right, the program playing unit 22 plays the received broadcast program. The play use right granting unit 15 subtracts from the program play use count a number that indicates how many times the surrogate play use right granting unit 54 has given a program play use right to the play use right obtaining unit 23. When the subtraction brings the program play use count to zero, the broadcast program is deleted from the video recorder 1 so that the broadcast program cannot be distributed from then on.

The procedure from the authentication of the plurality of receiving terminals 2A to 2N by one video recorder 1 to distribution from one video recorder 1 to the plurality of receiving terminals 2A to 2N is controlled separately for each receiving terminal. The video recorder 1 is capable of executing processing of distributing to the plurality of receiving terminals 2A to 2N concurrently.

This embodiment has a feature that a broadcast program recorded in the video recording center 5 is distributed to the receiving terminal 2A instead of a broadcast program recorded in the video recorder 1. The video recording center 5 distributes a broadcast program in place of the video recorder 1 only when the broadcast program is a program that has been recorded in the video recorder 1 once and the video recorder 1 is incapable of distributing due to limitations in the processing performance or the like of the video recorder 1. The system can thus distribute to a plurality of receiving terminals while maintaining consistency in program play use count.

In the case where a recorded broadcast program that is recorded by the video recording center 5 is edited in the video recorder 1 by cutting out commercials or the like before distributed directly from the video recorder 1 to the receiving terminal 2A, the receiving terminal 2A receives the edited broadcast program. In the case where a broadcast program is distributed from the video recording center 5 in place of the video recorder 1 due to limitations in the processing performance or the like of the video recorder 1, on the other hand, the broadcast program distributed to the receiving terminal 2A is unedited. Receiving the distribution of an unedited broadcast program and playing the unedited broadcast program on the receiving terminal 2A is also regarded as an exercise of the program play use right, and is included among incidents to be subtracted from the program play use count.

(10. Program Distribution System in which the Video Recording Center is a Program Server of a Broadcast Station)

While this embodiment describes a case where the video recording center 5 is a program distribution service provider, the video recording center 5 may be a program server of a broadcast station. In this case, a program broadcast by the broadcast station is recorded in the video recorder 1 once. When the video recorder 1 is incapable of distributing due to limitations in the processing performance or the like of the video recorder 1, the broadcast program is distributed to the receiving terminals 2A to 2N along with a program play use right from the program server of the broadcast station via a network as in the example of the distribution service provider described above. Whereas the recording of a broadcast program in the video recorder 1 from the video recording center 5 of the distribution service provider uses a communication network, the recording of a broadcast program in the video recorder 1 from the program server of the broadcast station is broadcast recording which uses broadcast waves of satellite broadcasting, terrestrial digital broadcasting, cable television, or the like.

(11. Program Distribution System in which a Program Play Use Right Includes Charging Information)

In the case where a program play use right of a distributed broadcast program includes charging information in addition to count information, the video recorder 1 manages the count information and the charging information as a program play use right. For example, a “charging information” item is added to the table of FIG. 6, and the system may be configured so that playing a broadcast program is permitted when the program play use count is 1 or higher and a fee is charged properly. In the case where a charging condition is set so that playing a broadcast program is permitted only within a given length of time since the recording of the broadcast program, regardless of the program play use count, a program play use time is managed instead of the program play use count. The system in this case is configured so that distribution is permitted only within a program play use time which is set in advance, and is no longer permitted once the use time passes.

In this mode, too, surrogate distribution can be executed if the program converting processing by the program converting unit 13 of the video recorder 1 and the transmitting processing by the program transmitting unit 14 require more than the video recorder 1 can handle when a broadcast program recorded in the video recorder 1 is distributed to a receiving terminal. The video recording center in that case performs re-encoding processing and program transmitting processing on the distribution target broadcast program in place of the video recorder 1, and distributes the recorded broadcast program, while protecting copyright, to the receiving terminal 2A which has received a program play use right and is permitted to play the broadcast program.

In the case where the same broadcast program is recorded in a plurality of video recorders inside a house, the program play use right of one of the video recorders and the program play use right of another of the video recorders may be managed together. The system then may employ a configuration in which, when the load on one of the video recorders is heavy, another of the video recorders that is available uses the program play use right of the heavy load video recorder to distribute the broadcast program to a receiving terminal.

The description given above expresses the respective components of the video recorder, the video recording center, and the receiving terminal as blocks of individual function units. Alternatively, the operations of the video recorder, the video recording center, and the receiving terminal may be implemented by running computer programs that define processing of those function units on processors (computers) that are respectively installed in the video recorder, the video recording center, and the receiving terminal. Processing procedures of such computer programs are, for example, as illustrated in the processing procedure diagrams of FIGS. 2, 3, 7, and 9.

A distribution system according to an embodiment of the present disclosure is provided with an agent server which handles processing of a distribution server in place of the distribution server, and is therefore effective for such cases as when the processing performance of a video recorder in converting a video recording format is not so high.

While the invention has been described with respect to preferred embodiments thereof, it will be apparent to those skilled in the art that the disclosed technique may be modified in numerous ways and may assume many embodiments other than those specifically described above. Accordingly, it is intended by the appended claims to cover all modifications of the invention that fall within the true spirit and scope of the invention.

This application is based on Japanese Patent Applications: No. 2012-010655 filed on Jan. 23, 2012 and No. 2012-138365 filed on Jun. 20, 2012, the entire contents of which are hereby incorporated by reference.

What is claimed is:

1. A contents distribution system, comprising:
a distribution server, which is connected to at least one information terminal in a manner that allows communication, configured to distribute, to the at least one information terminal, contents to which use right information for permitting playing the contents is set; and
an agent server, which is connected to the at least one information terminal and the distribution server in a manner that allows communication, configured to distribute the contents to the at least one information terminal in place of the distribution server when instructed from the distribution server,
wherein the distribution server comprises:
a control unit configured to determine whether to distribute the contents from the distribution server or to cause the agent server to distribute the contents based on at least one of a load state of the distribution server and a load state of a network between the distribution server and the at least one information terminal; and
a distribution instructing unit configured to transmit the use right information to the agent server and instruct the agent server to distribute the contents when the control unit determines to cause the agent server to distribute the contents, and
wherein the agent server comprises a surrogate distribution unit configured to distribute the contents and the use right information to the at least one information terminal when instructed from the distribution instructing unit.

2. The contents distribution system according to claim 1, wherein, the distribution instructing unit is configured to transmit the use right information and the contents to the agent server when the control unit determines to cause the agent server to distribute the contents.

3. The contents distribution system according to claim 1,
wherein the contents have an allotted use count so that the contents are usable only a limited number of times,
wherein the distribution server further comprises a first use right management unit configured to manage the allotted use count of the contents, and
wherein the agent server further comprises a second use right management unit configured to manage the allotted use count of the contents.

4. The contents distribution system according to claim 3,
wherein the first use right management unit is configured to reduce the allotted use count of the contents after the distribution instructing unit instructs the agent server to distribute the contents, and
wherein the second use right management unit is configured to increase the allotted use count of the contents after instructed by the distribution instructing unit to distribute the contents, and to reduce the allotted use count of the contents after the contents are distributed to the at least one information terminal.

5. The contents distribution system according to claim 1, wherein the distribution server further comprises:
an interface configured to obtain environment information of the at least one information terminal;
a contents converting unit configured to convert a format of the contents based on the environment information when the control unit determines to cause the distribution server to distribute the contents; and
a distribution unit configured to transmit the contents that have been converted by the contents converting unit and the use right information to the at least one information terminal.

6. The contents distribution system according to claim 5, wherein the environment information comprises at least one encoding information, resolution information, and communication band information about the at least one information terminal.

7. The contents distribution system according to claim 1, wherein the distribution server comprises a video recorder configured to record one of a broadcast program and a distributed program.

8. The contents distribution system according to claim 7, wherein the agent server comprises one of another video recorder that is placed in a house where the distribution server is installed, a server of a service provider which distributes programs, and a server of a broadcast station.

9. The contents distribution system according to claim 1, wherein, the distribution instructing unit is configured to instruct the agent server to delete the contents and to stop the distribution to the at least one information terminal when receiving an instruction to delete the contents during a period of time in which the agent server is distributing the contents to the at least one information terminal.

10. The contents distribution system according to claim 3, wherein, during a period of time in which the contents are being distributed to the at least one information terminal, in one of a case where not all of the contents are savable in a storage area of the at least one information terminal, and a case where the distribution of the contents is interrupted upon instruction from a user, the first use right management unit avoid changing the allotted use count of the contents next time the contents are distributed, and the distribution instructing unit instructs the agent server to resume the distribution of the contents from a point at which the distribution is stopped last time.

11. A distribution server, which is connectable by wire or wirelessly to at least one information terminal and to an agent server, for distributing contents to which use right information for permitting playing the contents is set, the distribution server comprising:
a control unit configured to determine whether to distribute the contents from the distribution server or to cause the agent server to distribute the contents based on at least one of a load state of the distribution server and a load state of a network between the distribution server and the at least one information terminal; and
a distribution instructing unit configured to transmit the use right information to the agent server and instructing the agent server to distribute the contents when the control unit determines to cause the agent server to distribute the contents.

12. An agent server, which is connectable by wire or wirelessly to the distribution server according to claim 11 and to at least one information terminal, for distributing contents to the at least one information terminal in place of the distribution server when instructed by the distribution server, the agent server comprising a surrogate distribution unit configured to transmit the contents and the use right information to the at least one information terminal when instructed from the distribution instructing unit.

13. A computer program, stored on a non-transitory computer-readable medium, to be executed by a computer mounted in a distribution server, which is connectable by wire or wirelessly to at least one information terminal and to an agent server, for distributing contents to which use right information for permitting playing the contents is set, the program causing a computer to execute:
determining whether to distribute the contents from the distribution server or to cause the agent server to distribute the contents based on at least one of a load state of the distribution server and a load state of a network between the distribution server and the at least one information terminal; and
transmitting the use right information for permitting playing the contents to the agent server and instructing the agent server to distribute the contents when it is determined that the agent server is caused to distribute the contents.

14. A computer program, stored on a non-transitory computer-readable medium, to be executed by a computer mounted in an agent server, which is connectable by wire or wirelessly to the distribution server according to claim 11 and to at least one information terminal, for distributing contents to the at least one information terminal in place of the distribution server when instructed by the distribution server, the program causing a computer to execute transmitting the contents and the use right information to the at least one information terminal when instructed from the distribution server.
